(19) United States
(12) Patent Application Publication
(10) Pub. No.: US 2024/0328523 A1
(43) Pub. Date: Oct. 3, 2024

(54) INTERCHANGEABLE MULTIPORT PINCH VALVE ASSEMBLY

(71) Applicant: Carten Controls Limited, Waterford (IE)

(72) Inventors: Declan IRISH, Waterford (IE); Lee CAULFIELD, Waterford (IE)

(73) Assignee: Carten Controls Limited, Waterford (IE)

(21) Appl. No.: 18/681,993

(22) PCT Filed: Aug. 9, 2021
(86) PCT No.: PCT/EP2021/072192

§ 371 Date: Feb. 7, 2024

(51) Int. Cl. F16K 11/22; F16K 7/04; F16K 27/00

(52) U.S. Cl. CPC F16K 11/22; F16K 7/04; F16K 27/003

(57) ABSTRACT

A pinch valve assembly is provided comprising a single piece block comprising one or more internal channels within the block for distribution of fluids, each of the one or more channels comprising an embedded sealable barrier, the single piece block further comprising one or more outlets for connection of one or more fluid conduits to the channels.

### FIELD OF THE INVENTION

This invention relates to a pinch valve multiport assembly. In particular, a pinch valve multiport assembly with a fully interchangeable and replaceable ‘throw-away’ valve body.

### BACKGROUND OF THE INVENTION

Bioprocessing involves the use of living cells or components to create products and compounds. Isolation of the living cells or components within a given process is of the utmost importance as contamination can render products unsuitable for use. To reduce the risk of contamination in the bioprocessing industry, many components are “single use”. Within the industry, “single-use” technologies refer primarily to polymeric components-such as tubing and bags. These components are used to house and transport cell culture medias for a single batch of product only. After use, the components are removed from production use and replacement components are used for the next production batch.

The intention of “single use” components is to protect the media from cross-contamination with alternative production batches, to eliminate the requirement for sterilisation and cleaning/sanitisation of process equipment, and to prevent bacterial contamination.

Tubing is used throughout bioprocessing to transport media from one process point to another, e.g. from one machine to another in a given processing plant. Tubing is often required to be sealed, for example to stop the flow of a given media through a tube and to prevent further transfer of media from one point to another in a process. This tubing is frequently single use and fabricated from polymeric materials.

Single-use polymeric devices are not durable devices and are generally rated for use with one production batch only. They are not designed to provide a reusable assembly.

Hybrid options are available which can allow for more than a single use. These often rely on a stainless steel valve construction which is reusable for ‘pinching’ of a molded polymer tube.

Such hybrid stainless-steel assemblies are more durable than a complete single use valve and tubing arrangement. Hybrid assemblies allow for re-use of the stainless steel pinch valve from batch-to-batch once new tubing is used as the product contact material. Furthermore, it is possible to create multiport or ‘block’ assemblies minimising dead space within the assembly of multiple valves.

However, the use of multiport assemblies within the one block assembly can lead to the erosion of the intended flexibility of single-use technologies—specifically the requirement to partially, or completely, disassemble the valve body base to remove the product contact silicon liner, replace with a virgin liner, re-assemble, and re-connect tubing to the liner ports. In an industry segment growing from the traditional clean-in-place (CIP), steam-in-place (SIP) automated cleaning and sterilising regime between batches—this critical and variable operation can prove complex and time-consuming with a high-risk factor for human error.

A pinch valve assembly that can remove this bulky, heavy, time-consuming, and risk-laden batch change-out process would be an improvement on the state of the art

### SUMMARY OF THE INVENTION

The present invention provides a pinch valve assembly comprising a single piece block comprising one or more internal channels within the block for distribution of fluids, each of the one or more internal channels comprising an embedded sealable barrier; the single piece block further comprising one or more outlets for connection of one or more fluid conduits to the channels.

The single piece block comprises internal channels within the block itself. Thus, the requirement to provide additional tubing for transfer of fluid within the block is obviated. In addition, the entire block may be removed from a production line and replaced in one simple action. Outlets are provided such that external fluid conduits may be brought into fluid communication with the internal channels as required to transfer fluids from the assembly.

The embedded sealable barrier provides a sealable contact surface suitable for contact with biological fluid material. A liner may be applied directly into the channel providing a coating around the internal surface of the channel. Alternatively, a liner may be in the form of a fluid conduit which is injection molded into the channel.

The pinch valve assembly may further comprise one or more openings for connection of one or more compressor elements to the internal channels. This is advantageous as it provides that compressor elements may be connected to the assembly via a configuration that allows the compressor element to provide compression into one or more of the internal channels.

The pinch valve assembly may be configured such that a compressor element connected to one of the one or more openings is moveable towards and through the opening for compression of the embedded sealable barrier in one of the internal channels to seal the internal channel. This is advantageous as applying a compression force to the embedded sealable barrier of one of the internal channels serves to push one side of the liner into contact with an opposite side, thus having the effect of sealing the internal channel and preventing fluid flow through the channel. Furthermore, this provides for the use of simple two-way single compressor element valve assemblies. The need for complex multiport multi-compressor element assemblies is overcome. This consequently overcomes the risk, complexity, and dead-leg hold-up volume concerns associated with such assemblies. Furthermore issues with bioburden and bacteria trap creation, and consequent contamination of biologics batches are also overcome.

The embedded sealable barrier may be a compressible surface internal to the assembly and the compressor element is configured to push the compressible surface into the internal channel to seal the internal channel. This is advantageous as the compressible surface can serve to apply compressive force to the embedded sealable barrier to seal the internal channel and prevent fluid flow through the channel. In this manner, the compression surface provides an embedded sealing mechanism within the block.

The embedded sealable barrier may be a compressible fluid conduit internal to the assembly and the compressor element is configured to push directly onto the surface of the compressible fluid conduit to seal the internal channel. This is provides an alternative manner to apply compressive force to the embedded sealable barrier to seal the internal channel and prevent fluid flow through the channel.

In use, the compressor element may be moveable between an open position wherein an embedded sealable barrier in one of the one or more channels is uncompressed to allow for fluid flow in the channel and a closed position wherein an embedded sealable barrier in one of the one or more channels is compressed to prevent fluid flow in the channel. As such, this provides that flow of fluid through the one or more channels in the single piece block may be controlled by the opening and closing of one or more compressor elements connected to the single piece block.

The single piece block may be a rectangular cuboid shape comprising the plurality of outlets for connection of one or more fluid conduits to the internal channels on a first, second and third surface and the plurality of openings for connection of one or more compressor elements to the internal channels on a fourth surface. This shape has the advantage that the block is simple to fabricate. Furthermore, the respective positions of the outlets for fluid conduits and the openings for connection of compressor elements provide that the conduits and compressor elements do not interfere with each other when connected to the block. In addition, it provides for ease of disconnection and extraction of a first block and subsequent ease of connection and installation of a second new block.

The single piece block may comprise a disposable polymer block. In this manner, the entire block and internal channels may be removed as one piece and be disposed of. This provides for significant efficiencies in productions lines when compared with existing systems where blocks have to be dismantled and have fluid conduits removed from internal chambers.

The embedded sealable barrier may be comprised of a silicone material. This provides a suitable material for injection into the channels of the block for coating the internal surfaces of the channels.

The internal channels may be configured for sterile distribution of fluids. The internal channels may be sterilised via a plasma coating. The channels are within the single piece block, and in effect are tunnels or conduits within the block. The channels may be initially sealed and as such, the channels are not exposed to the atmosphere. Thus they can remain sterile until installation for the distribution of fluids through the channels.

The single piece block may be further configured to be connectable to an additional single piece block. The single piece block may be connected to one or more additional single piece blocks to form a modular assembly. In this manner, a network of channels suitable for distribution of fluids in a given production line may be formed by the connection of multiple blocks together. As such, a connection of blocks may be tailored by a user to meet their production needs. As such, the modular functionality of the block provides a high degree of flexibility to the user to design and construct a network of channels to meet their production needs.

The compressor element may be configured to be manually actuated. This is advantageous as it provides for a manner of user control over the opening and closing of the closure assembly and thus provides for user control over the valve assembly itself. The compressor element may be configured to be pneumatically actuated. This is advantageous as it provides for rapid switching between the open position and closed position of the compressor element. It further provides a safeguard against failure of the value assembly as the pneumatic actuation can provide for the valve assembly to fail into an open position or a closed position, whichever is deemed most appropriate for a given process.

The invention as described thus provides for a single interchangeable or disposable block to transport biologics, for use with polymeric single use technologies in the bioprocessing industry. It further provides for overcoming the requirement for compression of polymeric tubing in general within the valve assembly. The one piece block may be manufactured from a high-density polymer to provide sufficient strength to withstand the force of the compressor element sealing on the liner, but provides a significantly reduced component mass for easy removal at batch changeout.

Critically, the design intent is the entire one-piece block now becomes ‘single-use’ and can be discarded, to be replaced by a fully interchangeable virgin single-piece block. This provides a significant advantage as no partial, or complete, removal of the valve body is required to allow silicone liner replacement and re-assembly. The full component is simply removed by the operator, and replaced by a new single component. Fluid conduits, in the form of tubing, or an alternative, can simply be connected to the block via the outlets provided in the block through a chosen mating methodology, for example triclamp, barb etc. . . .

In prior art systems, a compressor element of the pinch valve assembly may be moveable between an open position wherein a fluid conduit between the compressor and the holder elements is uncompressed to allow for fluid flow in the channel and a closed position wherein a fluid conduit between the compressor and separate holder elements is compressed to prevent fluid flow in the channel. This provides for compression, and as a result, closing of a fluid conduit which is positioned between the separate compressor and holder elements. This provides for effective termination of flow of media through the conduit when the compressor element is in the closed position. The conduit may be subsequently uncompressed, and as a result opened, to allow flow of media through the conduit to recommence if required. The holder and compressor obviously requiring separation to allow the fluid conduit liner to be assembled within the assembly.

The present invention however provides that the operating mechanism to compress the fluid conduit liner is embedded into the single block, therefore there are only two elements required to provide a sealable valve assembly—i) a top works containing the compressing element and providing the linear movement and force for compression, and ii) a base comprising the single block. The block contains the sealing element and furthermore the base may be comprised of a strengthened polymer base for resisting the compressing force of the top works. There is no requirement for a silicon tubing conduit liner to be replaced and assembled in between each production batch, the full valve body is simply replaced.

Consequently, the single piece block is truly single use and can be discarded during a drug batch changeout. No independent silicone liner element is now required, thus obviating the need for a multi-component and time-consuming changeout process.

### BRIEF DESCRIPTION OF THE DRAWINGS

FIG. 1 is a representation of a prior art pinch valve assembly illustrating the separated liner single product contact compressor element. This illustrates a pneumatically powered assembly.

FIG. 2 is a representation of a prior art pinch valve assembly illustrating the separated liner multiple product contact compressor elements. This illustrates a manually powered assembly.

FIG. 3 is a representation of the pinch valve assembly of the present invention with embedded sealing mechanism coupled to a pneumatically operated closure assembly

FIG. 4a i) and ii) is a cut away representation of the pinch valve assembly of the present invention, coupled to a pneumatically operated closure assembly with the compressor element in the open position.

FIG. 4b i) and ii) is a cut away representation of the pinch valve assembly of the invention, coupled to a pneumatically operated closure assembly with the compressor element in the closed position

FIG. 5 is a representation of the pinch valve assembly of the present invention with embedded sealing mechanism.

FIG. 6 is a cut-section representation of the pinch valve assembly of the present invention.

FIG. 7 is a representation of a topworks assembly housing and mounting plate positioned to receive a pinch valve assembly of the present invention.

FIG. 8 is a representation of the pinch valve assembly of the present invention fitted to a topworks assembly housing and mounting plate.

### DETAILED DESCRIPTION OF THE INVENTION

The invention will now be described with reference to the accompanying figures.

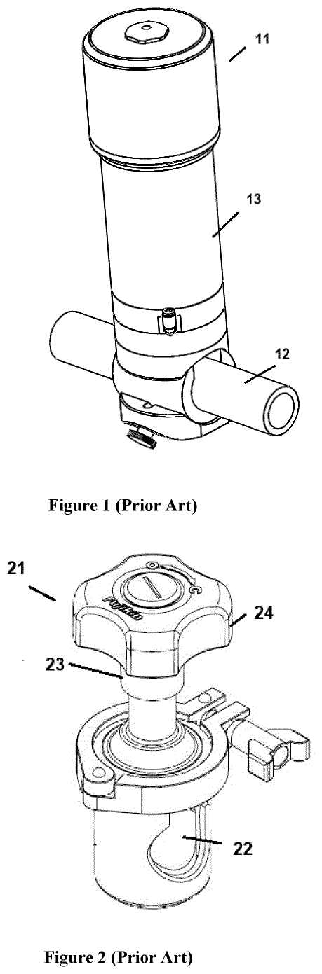

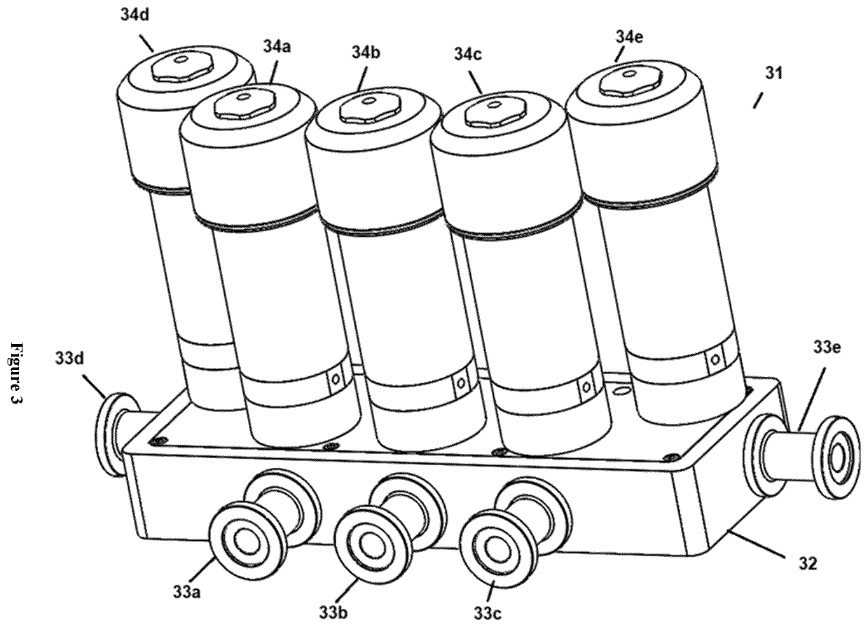

FIG. 1 is a representation of a prior art pinch valve assembly 11 illustrating a separated liner single product 12 and a contact compressor element 13. This example illustrates a pneumatically powered assembly. FIG. 2 is a representation of a prior art pinch valve assembly 21 illustrating an opening 22 for a separated liner to be inserted and a product contact compressor element 23 for compressing an inserted liner. This illustrates a manually powered assembly whereby a handle 24 may be manually turned to move a compressor element to apply pressure to seal the liner or conduit. In both FIGS. 1 and 2, the pinch valve assemblies 11, 21 comprise an assembly housing that is configured such that the compressor is moveable towards the holder within the assembly housing for compression of a fluid conduit which can be placed in an opening in the housing between the compressor and the holder. It is noted that such assemblies do not comprise channels or conduits integrated into the assemblies. Thus, for fluid flow to be achieved through such assemblies, fluid conduits in the form of tubing much be provided separately to the assembly.

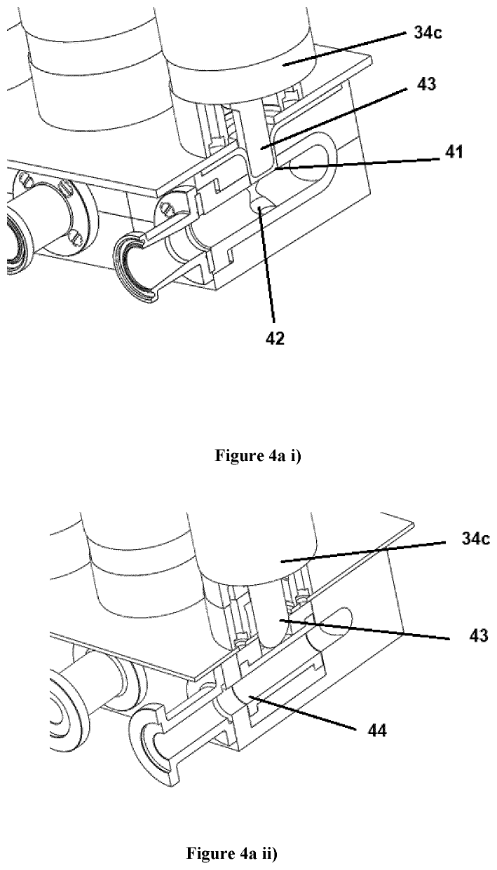

FIG. 3 shows the pinch valve assembly 31 of the present invention for compression of a multi-channel, multiport valve assembly. The pinch valve assembly 31 comprises a single piece block 32, or base block, comprising one or more internal channels within the block for distribution of fluids, such as for example biologics. The block may be comprised of a polymer material. The use of polymer material provides the advantage of a lightweight material for construction for the disposable body, easily manufactured (molded, machined etc.) to a required form and shape. The product contact embedded sealing barrier may be injection molded in the required shape-either directly into the body itself, or externally before assembly internally within the assembly. The product contact polymer and embedded sealing barrier may be made inert and sterile through a suitable process such as gamma irradiation. Plasma coating may also be applied to the internal surfaces that will touch the biologics. This ensures that any surface which makes contact with the biologics is sterile. The single piece block 32 further comprises one or more outlets 33 for connection of one or more fluid conduits to the internal channels. The example of FIG. 3 shows three outlets 33a, 33b, and 33c on the front surface of the block and two further outlets 33d, 33e, one on each side surface of the block. FIG. 3 further shows the single piece block in communication with a number of compressor elements 34. The pinch valve assembly is provided with one or more openings (not shown in FIG. 3) for connection of the compressor elements to the internal channels. The pinch valve assembly is thus configured such that a compressor element connected to one of the one or more openings is moveable towards and through the opening for compression of an embedded sealable mechanism in one of the internal channels. The example of FIG. 3 shows five compressor elements 34a, 34b, 34c, 34d, 34e in place connected such that they may provide a compressive force to five internal channels within the block 32.

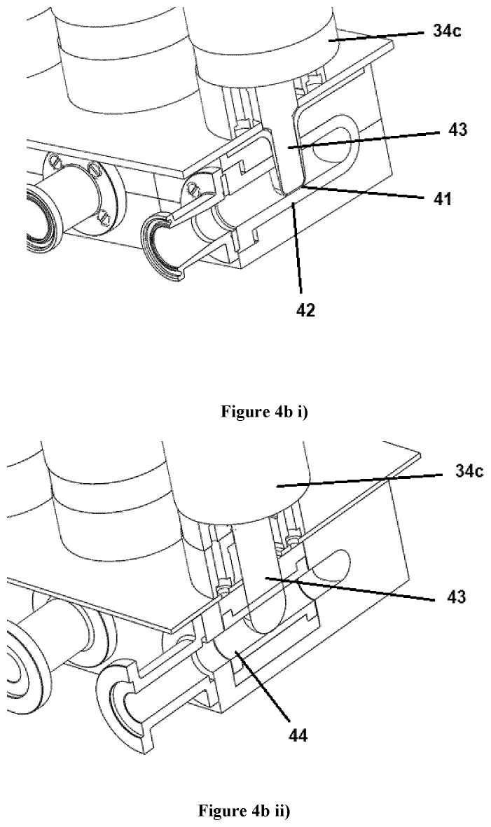

The compressor is moveable between an open position (wherein the compressor element is external to or protruding slightly through the block 32) and a closed position (wherein the said compressor travels through the block 32). The embedded sealing mechanism takes the form of a barrier. As further described below, the barrier may be external to the channel but moveable into the channel in order to seal the channel against the flow of fluids. Alternatively, the barrier lines the inside of surface of the internal channels. The barrier is made from a deformable material, for example silicone material—tubing or otherwise—or another polymeric material or tubing that is discarded along with the single piece base after use. The embedded embedded sealing mechanism may be uncompressed by movement of the compressor back to the open position. Two alternatives for providing an embedded sealing mechanism are described with reference to FIG. 4a i) and ii) and FIG. 4b i) and ii).

FIG. 4a i) and ii) is a cut away representation of the pinch valve assembly 31 of the present invention, coupled to a pneumatically operated compressor element 34c with the compressor element in the open position.

In the embodiment shown in FIG. 4a i), a compression element 41 is shown above the internal channel 42 in the block. A compression pin or piston 43 of the compressor element 34c is shown resting above the compression element 41. Thus, the channel 42 is open and fluid is permitted to flow through the channel. In this embodiment, the compression element forms the embedded sealable barrier as compression of the element will have the effect of sealing the channel to fluid flow.

In the embodiment shown in FIG. 4a ii), there is no compression element above the channel in the block. The compression pin or piston 43 is shown resting above a fluid conduit 44. Such a conduit may be added to the single block by an injection molding or other process. Thus, the conduit 44 is integrated into the block itself. Again, the channel is open and fluid is permitted to flow through the channel. In this embodiment, the conduit 44 itself forms the embedded sealable barrier as compression of the conduit will have the effect of sealing the channel to fluid flow.

FIG. 4b i) and ii) is a cut away representation of the pinch valve assembly 31 of the invention, coupled to a pneumatically operated compressor element 34c with the compressor element in the closed position. In the embodiment shown in FIG. 4b i), the compression element is shown compressed into the channel 42 in the block. The compression pin or piston 43 has thus applied compressive force to the compression element 41 causing it to move into the channel to seal the channel. Thus, the channel is closed and fluid is not permitted to flow through the channel.

In the embodiment shown in FIG. 4b ii), as noted there is no compression element. The compression pin or piston 43 is shown compressing the fluid conduit 44 itself within the channel to seal the channel. Thus, the channel is closed and fluid is not permitted to flow through the channel.

It should be noted in both embodiments that, in contrast to the prior art assemblies of FIGS. 1 and 2, additional tubing is not required to be supplied to provide a fluid path though the assembly. The internal channels provide such a fluid path. The fluid conduit of the second embodiment is integral to the device and is not required to be added by a user. External fluid conduits may also be attached to the assembly of the invention but only to transfer fluids from the assembly to elsewhere in a production line. The assembly itself does not require the addition of external tubing for fluid to pass through the assembly. It is further noted that in both embodiments, there is no contact between the compression pin and fluid flowing in the channels. In the first embodiment, the compression pin is in contact with the compression element and does not make contact with fluid in the channel. In the second embodiment, the compression pin is in contact with an outer surface of the fluid conduit and does not make contact with fluid in the channel.

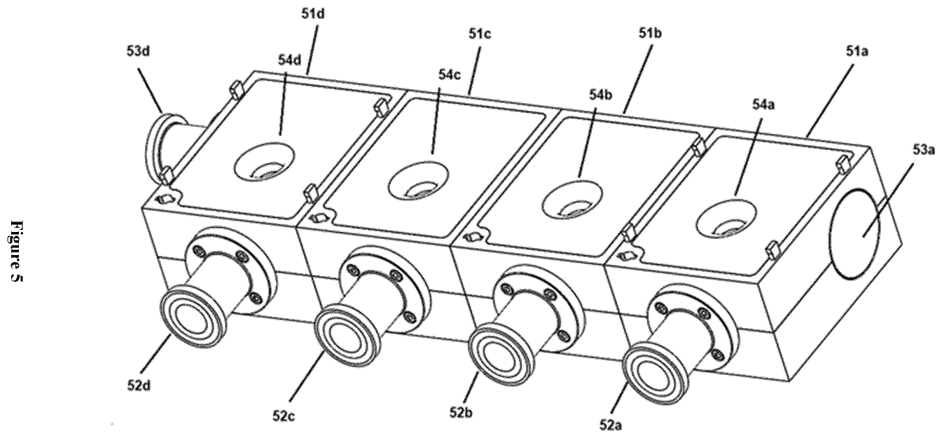

FIG. 5 is a representation of another embodiment of the pinch valve assembly of the present invention. FIG. 5 illustrates a single piece block 51a connected to an additional single piece block 51b. In total, four blocks 51a, 51b, 51c, 51d are connected forming a modular assembly. Note that FIG. 3 shows a single piece block comprising three outlets on the front surface of the block and two further outlets, one on each side surface of the block while the blocks of FIG. 5 comprise a single outlet 52 a, 52b, 52c, 52d on the front surface of the block and two further outlets one on each side surface of the block. The side outlet 53d of block 51d can be seen as can the side outlet 53a of block 51a. Outlets of block 51b and 51c are hidden by virtue of the blocks being connected. It is noted that an outlet, for example 53a, may be sealed if not in use. Other block configurations are possible with a series of outlets on the front and sides of the blocks. It is noted also that such blocks may also be connected in the manner shown in FIG. 5, i.e. the connection of multiple blocks to form a modular assembly is not limited to the connection of blocks with a single front surface outlet as shown in FIG. 5. The openings 54a, 54b, 54c, 54d for connection of one or more compressor elements to the internal channels are also shown in FIG. 5.

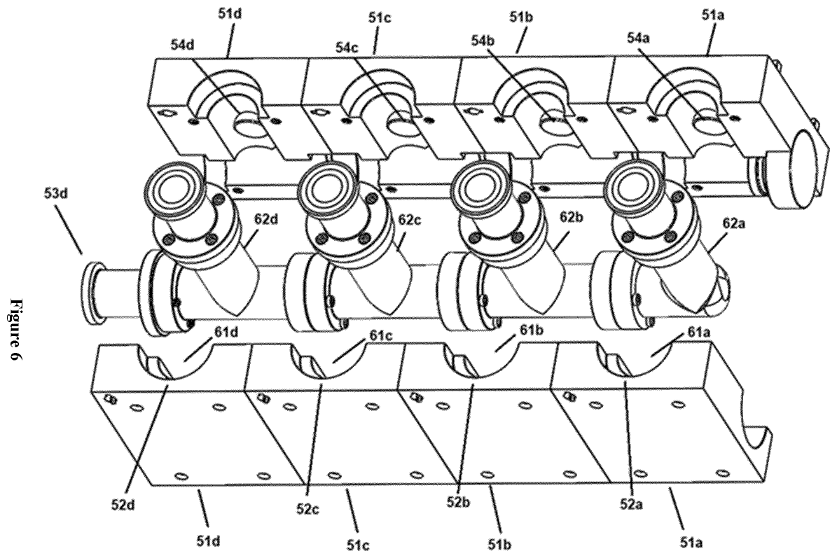

FIG. 6 shows a cut-section representation of the modular assembly of FIG. 5. It should be noted that the cut-section is for illustrative purposes only. It is intended that the block is provided a single piece comprising the internal channels. It is not intended that the block is separable as shown. Each of the blocks is provided with an internal channel. The internal channels 61a, 61b, 61c, 61d of each block may be joined so that a user may construct fluid paths suitable for their needs. In the example shown, a fluid conduit 62a, 62b, 62c, 62d is integrated into each block. The fluid conduit further serves as the embedded sealable barrier and may be sealed by a compression pin as described with respect to FIG. 4b ii).

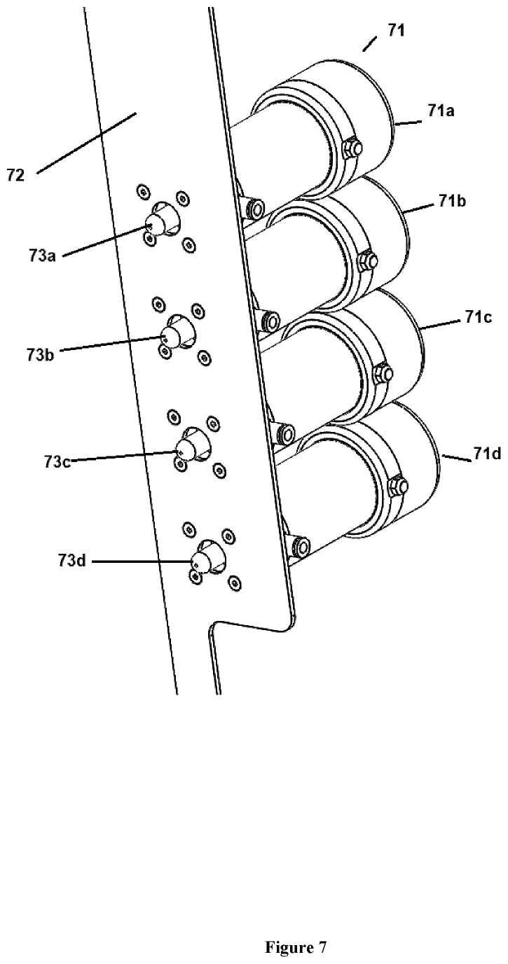

FIG. 7 is a representation a topworks assembly housing 71 and mounting plate 72. The topworks assembly comprises a series of four compressor elements 71a, 71b, 71c, 71 d suitable for compression of the embedded sealable barrier of the valve assembly. The compression pins or pistons 73a, 73b, 73c, 73d of the compressor elements are seen to protrude slightly through the mounting plate 72. A valve assembly according to the present invention may be fitted to a mounting plate 72 such that the openings in the assembly align with the compression pins or pistons 73a, 73b, 73c, 73d. This ensures that when a compressor is activated, the pin or pistons may pass though the mounting plate and the valve assembly opening to apply compression to the embedded sealable barrier in a channel of the assembly.

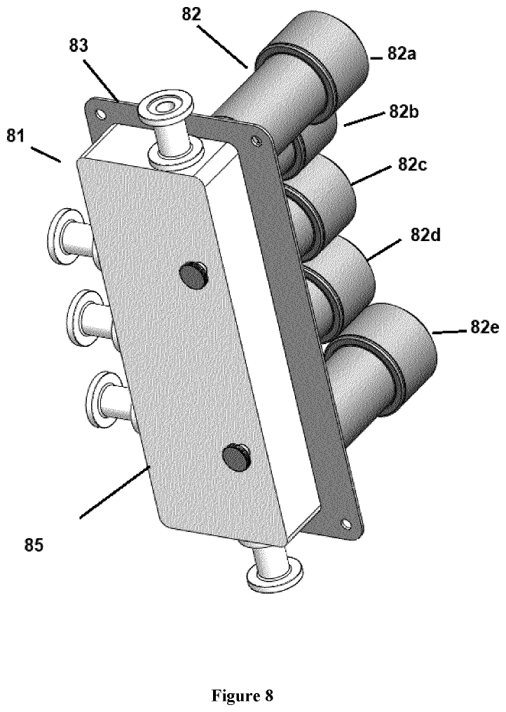

FIG. 8 shows such an arrangement wherein a pinch valve assembly 81 of the present invention is fitted to a topworks assembly housing 82 and mounting plate 83. The topworks assembly comprise a series of five compressor elements 84a, 84b, 84c, 84d, 84e, compared to the four elements of FIG. 7. The valve assembly base block 85, may be assembled to a process fixture (filtration, purification) skid wall, bracket, fixture, fitting, or free-standing assembly through one simple quick fit operation. Thus, from FIG. 8, it can be seen that once a given process is completed, the valve assembly may be removed as a single unit from the mounting plate and a new assembly attached, again in alignment with the series of compressor elements. This is a very efficient procedure requiring little process downtime. As the compressor elements have not been in contact with any fluid, no issues of cross contamination can arise. Thus, the need for additional sterilisation of compressor element is obviated. Once the new assembly is in place, a new fluid transfer process is ready to be undertaken.

Thus flow channels for multiple compressing elements may be changed in just one single quick-fit operation, while maintaining the embedded sealing mechanism purity characteristics. The valve assembly block is provided as a sterile component. This may be achieved by gamma radiation of the block. Furthermore, the internal channels are sterilised via a plasma coating.

Providing the valve assembly base block as a single-use disposable element eradicates a time-consuming drug batch changeout process.

In addition, to change between tubing sizes, a first valve assembly base block may be removed and replaced with a second valve assembly base block of suitable dimensions. i.e. the block may be dimensioned according to a range of block and internal channel dimensions. Therefore, no full valve replacement is required for scale-up, or scale-down of a given process. The different valve assembly dimensions may be accounted for in initial configuration of the topworks compressor elements such that, regardless of dimensions, the same closure and compression stroke for compression to the required depth and force to seal the embedded sealing mechanism against fluid flow pressure is provided without damage to the embedded sealing mechanism structure.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A pinch valve assembly comprising:
a single piece block comprising one or more internal channels within the block for distribution of fluids, each of the one or more internal channels comprising an embedded sealable barrier;
the single piece block further comprising one or more outlets for connection of one or more fluid conduits to the channels.

2. The pinch valve assembly of claim 1, further comprising one or more openings for connection of one or more compressor elements to the internal channels.

3. The pinch valve assembly of claim 2, configured such that a compressor element connected to one of the one or more openings is moveable towards and through the opening for compression of the embedded sealable barrier in one of the internal channels to seal the internal channel.

4. The pinch valve assembly of claim 3, wherein the embedded sealable barrier is a compressible surface internal to the assembly and the compressor element is configured to push the compressible surface into the internal channel to seal the internal channel.

5. The pinch valve assembly of claim 3, wherein the embedded sealable barrier is a compressible fluid conduit internal to the assembly and the compressor element is configured to push directly onto the surface of the compressible fluid conduit to seal the internal channel.

6. The pinch valve assembly of claim 3, wherein, in use, the compressor element is moveable between an open position wherein an embedded sealable barrier in one of the one or more channels is uncompressed to allow for fluid flow in the channel and a closed position wherein an embedded sealable barrier in one of the one or more channels is compressed to prevent fluid flow in the channel.

7. The pinch valve assembly of claim 3, wherein the single piece block is a rectangular cuboid shape comprising the plurality of outlets for connection of one or more fluid conduits to the internal channels on a first, second and third surface and the plurality of openings for connection of one or more compressor elements to the internal channels on a fourth surface.

8. The pinch valve assembly of claim 1, wherein the single piece block comprises a disposable polymer block.

9. The pinch valve assembly of claim 1, wherein the embedded sealable barrier is comprised of a silicone material.

10. The pinch value assembly of claim 1, wherein the internal channels are configured for sterile distribution of fluids.

11. The pinch valve assembly of claim 10, wherein the internal channels are sterilised via a plasma coating.

12. The pinch valve assembly of claim 1, wherein the single piece block is further configured to be connectable to an additional single piece block.

13. The pinch valve assembly of claim 12, wherein the single piece block is connected to one or more additional single piece blocks to form a modular assembly.

14. The pinch valve assembly of claim 3, wherein the compressor element is configured to be manually actuated.

15. The pinch valve assembly of claim 3, wherein the compressor element is configured to be pneumatically actuated.
